(19) United States
(12) Patent Application Publication
(10) Pub. No.: US 2014/0218627 A1
(43) Pub. Date: Aug. 7, 2014

(54) TELEVISION SET

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: KANG WU, Shenzhen (CN); BO TIAN, Shenzhen (CN); YU HAN, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/157,919

(22) Filed: Jan. 17, 2014

(30) Foreign Application Priority Data
Feb. 4, 2013 (CN) 2013100426211

(51) Int. Cl. H04N 5/655

(52) U.S. Cl. CPC H04N 5/655
USPC 348/839

(57) ABSTRACT

A television set includes a front cover, a back cover, a display panel, a receiving body, and a circuit board. The front cover and the back cover define a receiving space. The display panel and the receiving body are received in the receiving space, and the circuit board is latched in the receiving body and drives the display panel. The front cover defines a first notch on a side frame; the receiving body is inserted into the receiving space via the first notch. The circuit board is physically separated from the display panel, thus the circuit board is easy to separate from the display panel. Therefore it is convenient to repair the television set.

### FIELD

The present disclosure relates to a television set.

### BACKGROUND

A television set has a plurality of function modules, such as a display control module, a communication module, a network module, and a video module. The plurality of function modules are integrated on a circuit board. The circuit board and a display panel are both fixed on a cover of the television set, which makes the circuit board difficult to separate from the display panel. Therefore, it is inconvenient to repair the television when malfunctions occur.

Therefore, what is needed is a means to overcome the above-described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is an isometric view of a television set according to one embodiment.

FIG. 2 is similar to FIG. 1, but showing the television set in another view.

FIG. 3 is an exploded view of the television set of FIG. 1.

FIG. 4 is an enlarged view of the circled part IV of FIG. 3.

FIG. 5 is similar to FIG. 3, but showing the television set in another view.

### DETAILED DESCRIPTION

Reference will be made to the drawings to describe various embodiments.

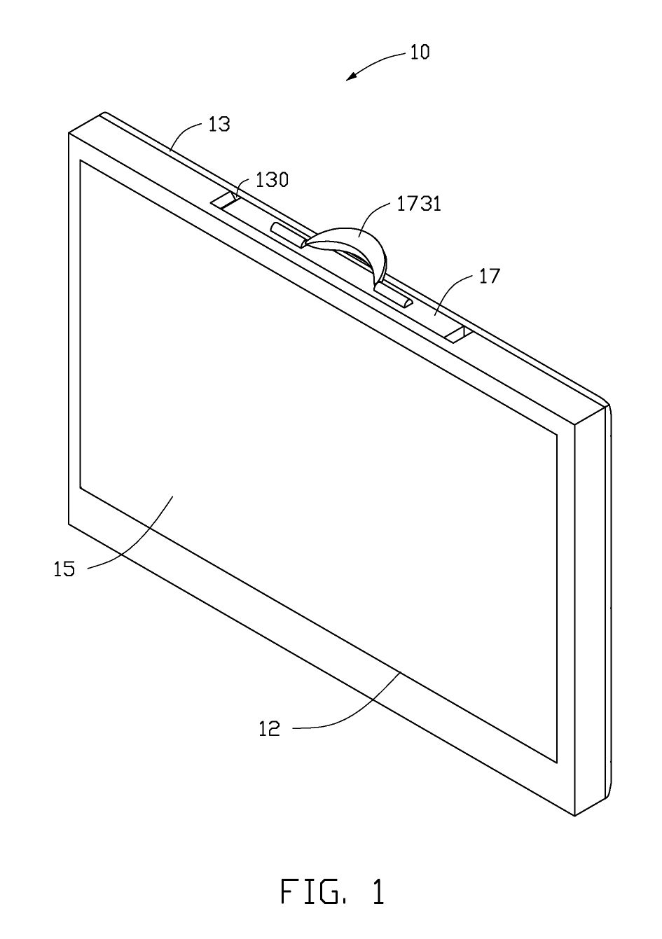

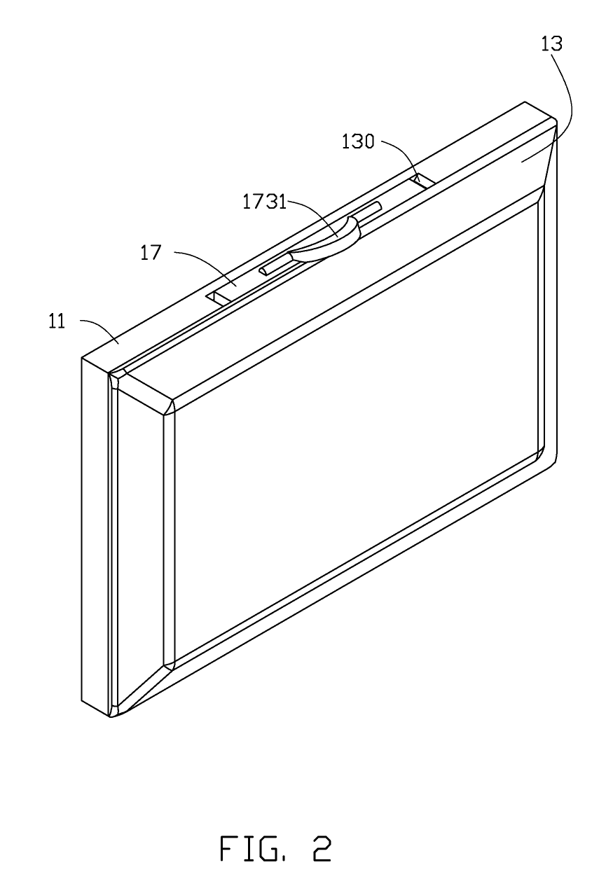

FIG. 1 shows an isometric view of a television set 10 according to one embodiment. FIG. 2 is similar to FIG. 1, but shows another view of the television set 10. The television set 10 includes a front cover 11, a back cover 13, a display panel 15, and a receiving body 17.

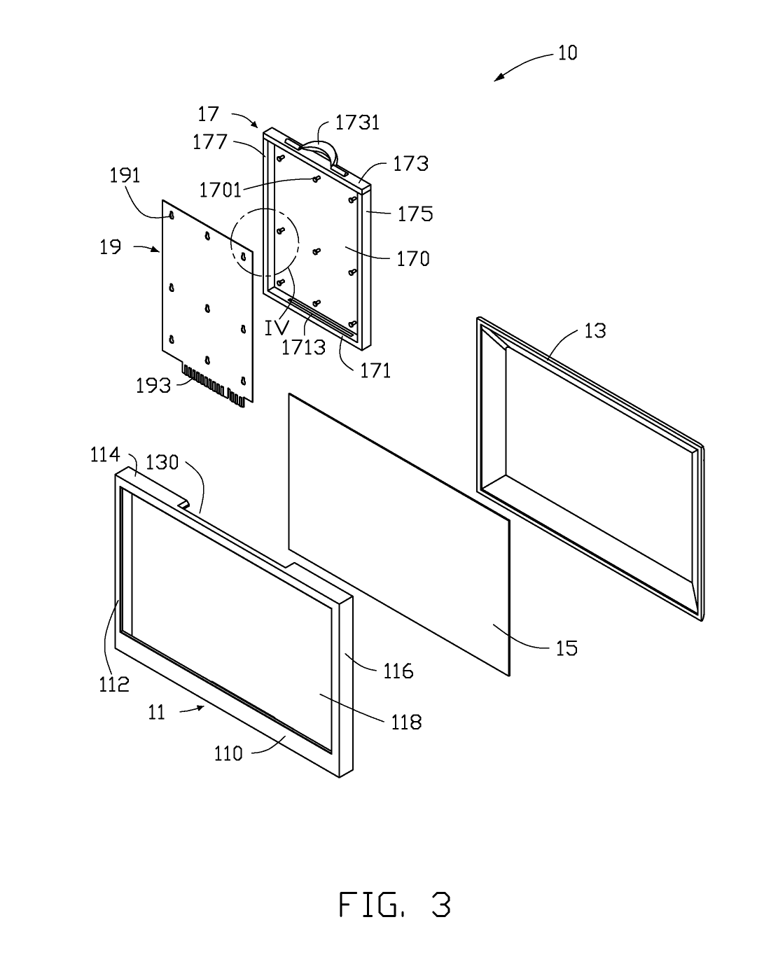

FIG. 3 shows an exploded view of the television set 10. The front cover 11 includes a first side frame 110, a second side frame 112, a third side frame 114, and a fourth side frame 116. The first side frame 110 is opposite to the third side frame 114 and the second side frame 112 is opposite to the fourth side frame 116. A length of the first side frame 110 is substantially equal to a length of the third side frame 114. A length of the second side frame 112 is substantially equal to a length of the fourth side frame 116. The length of the first side frame 110 is greater than the length of the second side frame 112.

The front cover 11 and the back cover 13 define a receiving space to receive the display panel 15 and the receiving body 17. The front cover 11 defines a first opening 118 exposing the display panel 15. The third side frame 114 defines a first notch 130. The receiving body 17 is inserted into the receiving space via the first notch 130.

In the embodiment, the display panel 15 can be a liquid crystal display (LCD) panel, or an organic light emitting diode (OLED) panel, for example.

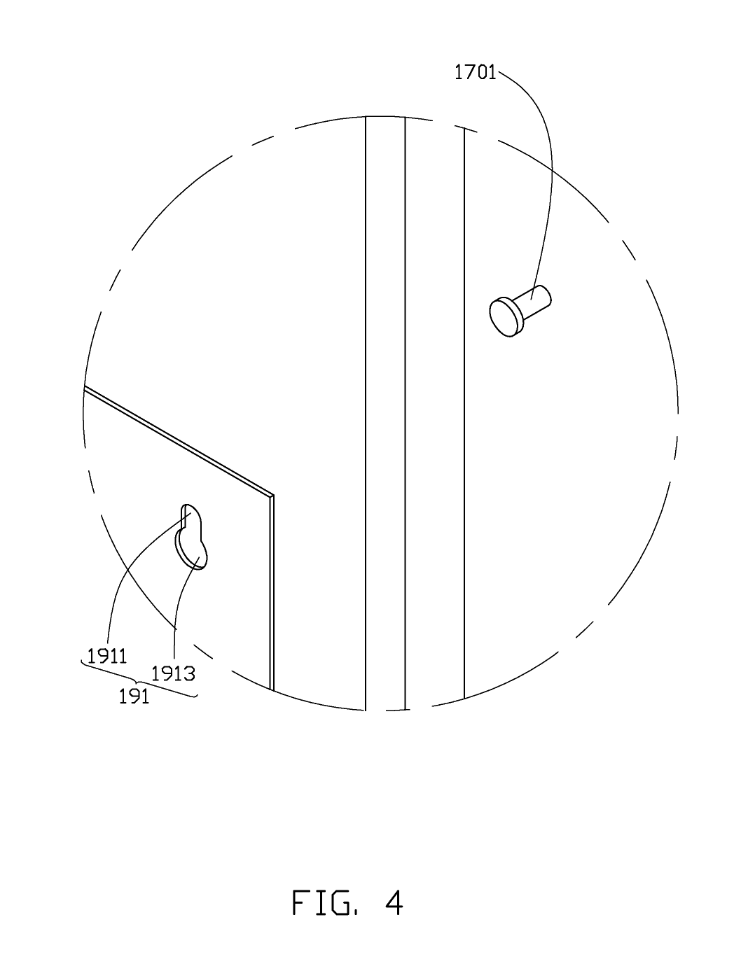

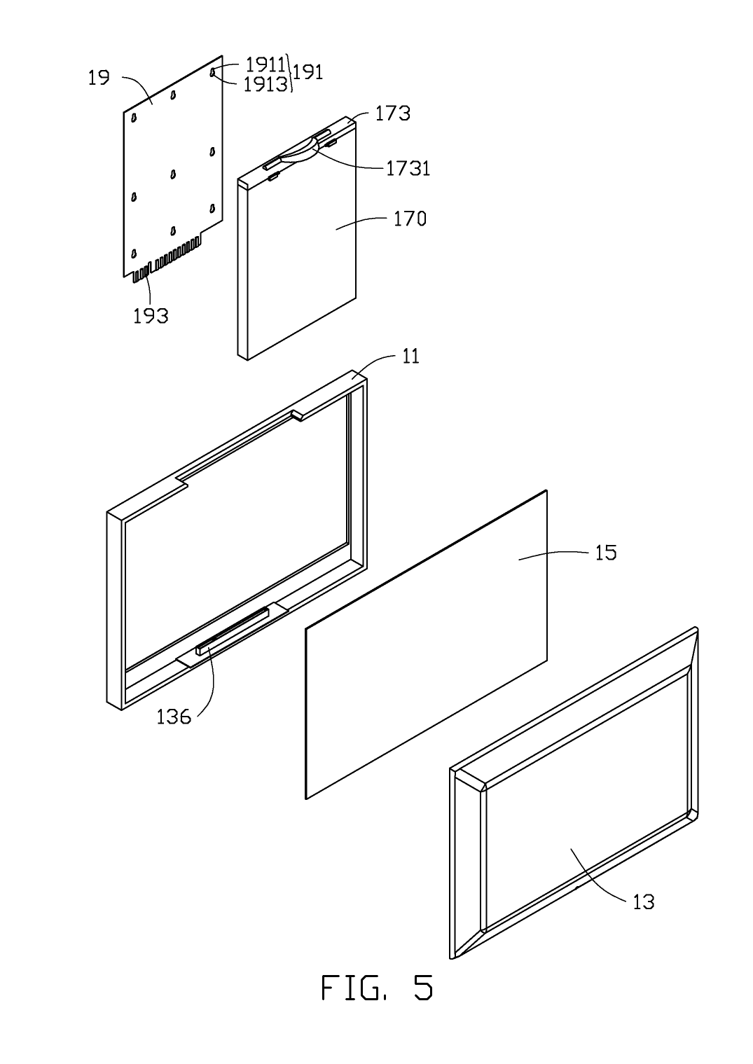

FIG. 4 is an enlarged view of a circled part IV of the television set 10 of FIG. 3. FIG. 5 is similar to FIG. 3, but showing another view of the television set. The television set 10 further includes a circuit board 19. The circuit board 19 drives the display panel 17 and has a plurality of function modules, such as a video signal processing module, and an audio signal processing module, and a communication module. The circuit board 19 is latched in the receiving body 17. A first connector 136 is arranged on the first side frame 110 facing the first notch 130.

The receiving body 17 includes a bottom plate 170, a first side plate 171, a second side plate 173, a third side plate 175, and a fourth side plate 177. The first side plate 171, the second side plate 173, the third side plate 175, and the fourth side plate 177 extend from the bottom plate 170. The first side plate 171 is opposite to the second side plate 173 and the third side plate 175 is opposite to the fourth side plate 177. The second side plate 173 is capable of rotating relative to the bottom plate 170. A second opening 1713 is defined on the first side plate 171. The bottom plate 170 includes a plurality of bolts 1701 for fastening the circuit board 19 thereto. In the embodiment, the bolts 1701 are T-shaped. A handle 1731 is rotatably arranged on the second side plate 173.

The circuit board 19 defines a plurality of fixing holes 191 to couple with the bolts 1701. In the embodiment, each fixing hole 191 is a gourd hole. Each fixing hole 191 includes a first fixing hole 1911 communicating with a second fixing hole 1913, and a diameter of the first fixing hole 1911 is less than a diameter of the second fixing hole 1913. A gold finger 193 is arranged at one end of the circuit board 19.

In assembly, the circuit board 19 is latched in the receiving body 17, the gold finger 193 protrudes out of the second opening 1713. When the receiving body 17 is inserted into the receiving space, the gold finger 193 is electrically connected to the first connector 136, thus the circuit board 19 is capable of driving the display panel 17. In addition, all of the function modules on the circuit board 19 are capable of normally operating and providing corresponding functions to the television set 1.

The circuit board 19 can be physically separated from the display panel 15, thus allowing a technician easy access for repairing the television and the circuit board 19.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. A television set, comprising:
a front cover and a back cover defining a receiving space,
a display panel and a receiving body received in the receiving space, and
a circuit board driving the display panel and having a plurality of function modules, wherein the circuit board is latched in the receiving body;
wherein the front cover defines a first notch on a side frame, and the receiving body is inserted into the receiving space via the first notch, and the circuit board is electrically connected to the display panel.

2. The television set of claim 1, wherein a first connector is arranged on the front cover to face the first notch.

3. The television set of claim 2, wherein the receiving body comprises a bottom plate, a first side plate, a second side plate, a third side plate, and a fourth side plate; the first side plate, the second side plate, the third side plate, and the fourth side plate extend from the bottom plate; the second side plate is capable of rotating relative to the bottom plate.

4. The television set of claim 3, wherein a plurality of fixing bolts are arranged on the bottom plate, and the circuit board comprises a plurality of fixing holes corresponding to the plurality of fixing bolts to fix the circuit.

5. The television set of claim 4, wherein the fixing bolts are T-shaped.

6. The television set of claim 4, wherein each fixing hole is a gourd hole and comprises a first fixing hole and a second fixing hole, the first fixing hole communicates with the second fixing hole, and a diameter of the first fixing hole is less than a diameter of the second fixing hole.

7. The television set of claim 4, wherein a gold finger is arranged at one end of the circuit board, and an opening is defined on the first side plate; when the circuit board is latched in the receiving body, the gold finger protrudes out of the first opening.

8. The television set of claim 7, wherein when the receiving body is inserted into the receiving space, the gold finger is electrically connected to the first connector.

9. The television set of claim 3, wherein a handle is rotatably arranged on the second side plate.

10. A television set, comprising:
a front cover and a back cover defining a receiving space,
a display panel and a receiving body received in the receiving space,
a circuit board driving the display panel, wherein the circuit board is latched in the receiving body and a gold finger of the circuit board protrudes out of the receiving body; and
the receiving body inserted into the receiving space via a first notch defined in the front cover, and the circuit board is electrically connected to the display panel via the gold finger and a first connector arranged facing the first notch.

11. The television set of claim 10, wherein the receiving body comprises a bottom plate, a first side plate, a second side plate, a third side plate, and a fourth side plate; the first side plate, the second side plate, the third side plate, and the fourth side plate extend from the bottom plate, the second side plate is capable of rotating relative to the bottom plate.

12. The television set of claim 11, wherein a plurality of fixing bolts are arranged on the bottom, and the circuit board comprises a plurality of fixing holes corresponding to the plurality of fixing bolts to fix the circuit.

13. The television set of claim 12, wherein the fixing bolts are T-shaped.

14. The television set of claim 12, wherein each fixing hole is a ground hole and comprises a first fixing hole and a second fixing hole, the first fixing hole communicates with a second fixing hole, and a diameter of the first fixing hole is less than a diameter of the second fixing hole.

15. The television set of claim 14, wherein a gold finger is arranged at one end of the circuit board, and an opening is defined on the first side plate, and when the circuit board is latched in the receiving body, the gold finger protrudes out of the first opening.
